(19) United States
(12) Patent Application Publication
(10) Pub. No.: US 2011/0014845 A1
(43) Pub. Date: Jan. 20, 2011

(54) Water Toy

(75) Inventors: Daniel Monahan, Carlsbad, CA (US); Marco Schilling, El Cajon, CA (US)

Correspondence Address: THE MUELLER LAW OFFICE, P.C., 12951 Harwick Lane, San Diego, CA, 92130, US

(73) Assignee: DANO2, LLC, Carlsbad, CA (US)

(21) Appl. No.: 12/836,689

(22) Filed: Jul. 15, 2010

Related U.S. Application Data
(60) Provisional application No. 61/270,990, filed on Jul. 16, 2009.

(51) Int. Cl. A63H 23/00; A61J 17/00

(52) U.S. Cl. 446/153; 606/235

(57) ABSTRACT

A water toy is disclosed herein. In one aspect, the water toy is comprised of a non-rigid material which has an injection molded main body and flap. This flap is integral with the main body and connected via a living hinge. The flap can be either in an open or closed position. When the flap is in the closed position, an inner chamber is defined and it is capable of containing enough air to enable the toy to float. When the flap is in the open position, access is provided to the inner chamber for cleaning or drying. Teething portions may also be provided in features of the water toy.

### CROSS-REFERENCE TO RELATED APPLICATIONS

The present application claims priority and benefit to U.S. Provisional Patent Application 61/270,990 filed Jul. 16, 2009 entitled “Process for generating safe toys—bug bites, duck”, which is hereby incorporated by reference as if set forth in full in this application for all purposes.

### BACKGROUND OF THE INVENTION

Toys are frequently used by children during play. The variety of designs is virtually limitless as are the materials used in manufacturing. It is common in the art to have electronics designed into the toy for light, sound or motion powered by batteries. A panel, flap or hatch may provide access to the battery compartment. This panel, flap or hatch may be permanently attached in one area, for example, hinged, or may be removable and attached by external fasteners. Some plastic toys may also have a living hinge connecting two members that close unto one another. These members may be a flap and main body, or simply, two members that mate in a clamshell manner. A secured, closed position may be achieved by various means such as snap fit, latching mechanisms or external fasteners. It is also known in the art that plastic toys may have a built-in internal structure, for example, ribs, braces or reinforcements, for strengthening and rigidity.

Water toys are common items used by children during, for example, bathing or swimming. These water toys may be designed to float while others may be designed to sink. Floating water toys have been designed in many configurations over the years to provide interesting new forms of amusement. These toys often resemble animals and common themes include frogs, dolphins and bears but none of these are as iconic as the rubber duck. While the appearance and physical size of floating water toys may vary substantially, most floating water toys are constructed of a soft, vinyl material such as polyvinyl chloride, commonly known as PVC.

PVC is used extensively in toys because it is rotomoldable, inexpensive, durable and easy to assemble. In order to soften and permit flexibility of the PVC material, additional chemicals (plasticizers) are added to the PVC to change the chemical consistency of the product, however these additives do not bond well to PVC. PVC products are known to have human and environmental health risks associated with the use and manufacturing. It is known that these plasticizers can leach out of the product thus having significant health risks associated with using the product, especially if the product is in a child's mouth and chewed on. Also, during the manufacture of PVC, dioxin and other pollutants are emitted into the air, water and land, which present both acute and chronic health hazards as well as pollution.

There are many methods for manufacturing plastic toys. For example, blow molding may be used for bowling pins, figurines or balls. Injection molding is a common method for making slot cars, toddler ride-on toys and game pieces. Hollow plastic toys, such as doll heads or outdoor playsets are often manufactured by using a rotation molding (rotomolding) process.

It is known in the art that most plastic toys are manufactured outside of the United States of America (USA) then imported to the USA. In the last few years, the amount of toys being recalled in the USA by the Consumer Product Safety Commission has greatly increased. Many of these recalls involve high levels of lead exposure found in either the paint or plastic of the toy. Paint containing lead was banned in the USA in 1978 but it is still widely used in other countries and therefore can be found on imported toys. As mentioned previously, additional chemicals added to plastic may leach out. Because of the amount of recalls, consumers are concerned about toys manufactured outside of the USA and are seeking safer, non-toxic toys manufactured in the USA.

### BRIEF SUMMARY OF THE INVENTION

A water toy is disclosed herein. In one aspect, the water toy is comprised of a non-rigid material which has an injection molded main body and flap. This flap is integral with the main body and connected via a living hinge. The flap can be either in an open or closed position. When the flap is in the closed position, an inner chamber is defined and is capable of containing enough air to enable the toy to float. When the flap is in the open position, access is provided to the inner chamber for cleaning or drying.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 provides a perspective view of a water toy according to the present invention;

FIG. 2 shows a side view of a water toy with the flap in the closed position;

FIG. 3 depicts a side view of a water toy with the flap in the open position;

FIG. 4 details a rear view of the water toy with the flap in the closed position;

FIG. 5A is a top view of a water toy with the flap in the open position;

FIG. 5B is a top view of a water toy with the flap in the open position illustrating another embodiment of the living hinge;

FIGS. 6A provides a bottom view of a water toy with the flap in the open position revealing an inner chamber with an inner structure;

FIG. 6B is a bottom view of a water toy with the flap in the open position revealing an inner chamber illustrating a further embodiment of the inner structure; and

FIG. 7 is section D-D of FIG. 1 and depicts a cutaway view of a water toy with the flap in the closed position further detailing the inner chamber.

### DETAILED DESCRIPTION OF THE EMBODIMENTS

The water toy of the present invention provides significant health and safety advantages for the user who is typically a young child that may place the water toy in their mouth for extended periods of time. The material used in the construction of the water toy is safe and non-toxic avoiding the issue of dangerous chemicals leaching into the child's mouth with no known adverse health conditions to the user. Next, the product design is fundamentally different than other water toys currently available in that the design accommodates manufacturability of a safe, non-toxic material which cannot be effectively fastened or sealed via bonding agents. Additionally, designed in safety features remove the risk of the user swallowing, choking or suffocating when using this product. Also, the risk of mold developing and accumulating inside the toy is eliminated because of a unique flap feature which allows water to be drained. The flap facilitates cleaning and drying for the inside of the water toy, which prevents mold. Mold is extremely dangerous for children and is often found in currently available water toys. Lastly, this product may be completely made in the USA. These unique features will be evident and readily appreciated as embodiments according to the present invention are described in more detail in reference to the accompanying figures.

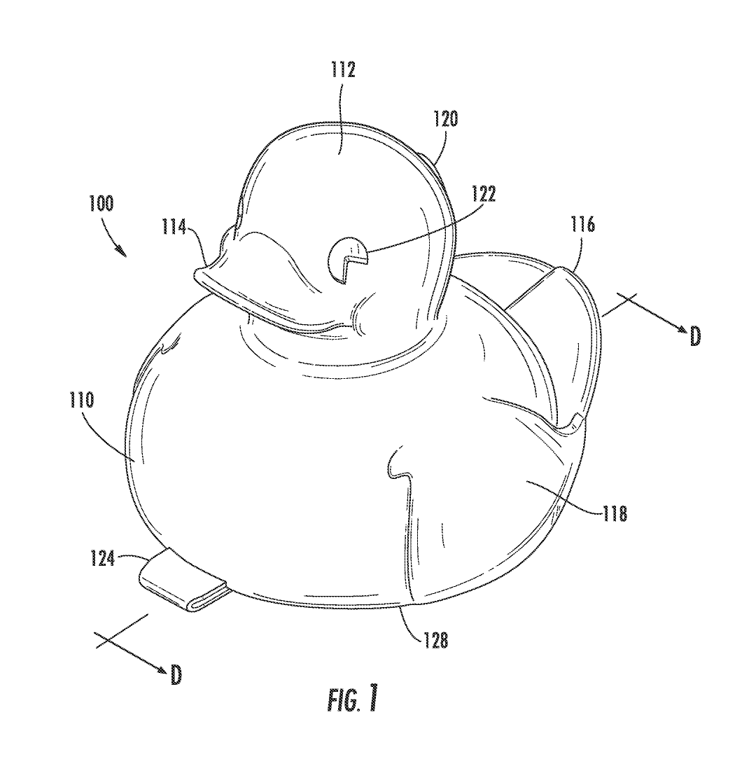

An embodiment according to the present invention is depicted as a water toy 100 in FIG. 1. Water toy 100 has a main body 110 that includes head 112, beak 114, tail 116, wings 118 (symmetrical), hair tuft 120 and eyes 122 (symmetrical). A living hinge 124 connects flap 128, which is located under the bottom portion of water toy 100. Note that water toy 100 is depicted in the form of a duck only by example. Water toy 100 may also take the form of other shapes such as a frog, a star or an automobile.

The water toy may be made from many different materials. For example, a non-PVC thermoplastic elastomer (TPE), in particular, Medalist® MD-155 marketed by Teknor Apex Company may be used. This material is FDA compliant Medical Grade and tests conducted by an independent laboratory found the lead content less than 10 parts per million (ppm). The exact lead level is unknown because presently, the test equipment cannot test to any lower limit. The current federal restriction for consumer products intended for children 12 and under states that the product cannot have more than 300 ppm of lead content in any accessible part and the American Academy of Pediatrics recommends no more than 40 ppm of lead contamination. In other embodiments, any non-toxic material may be used, for example, a thermoplastic polyurethane (TPU), a low density polyethylene (LDPE), a linear low density polyethylene (LLDPE), silicone, or other thermoset materials. These safer, non-toxic materials are needed to improve consumer health and the environment. The present invention may be manufactured solely in the USA and is in full compliance with all International, European Union and USA mandatory and voluntary toy safety standards as well as the Environmental Protection Agency (EPA).

Currently, viable safe, non-toxic materials are not commonly used in manufacturing hollow parts of water toys. Because of the limitations of rotational molding for this material and design, the process of injection molding is used. In injection molding, an extractable tool with drafts cores out the toy cavity resulting in a hollow product, or a toy with an inner chamber. As mentioned above, the present invention includes flap 128 attached to main body 110 via living hinge 124. When flap 128 is in a closed position, flap 128 closes the inner chamber inside main body 110 and allows the water toy to float. It is known in the art that an adhesive will not bond well to non-toxic material, i.e. flap 128 cannot be effectively fastened via bonding agents when using the safer materials.

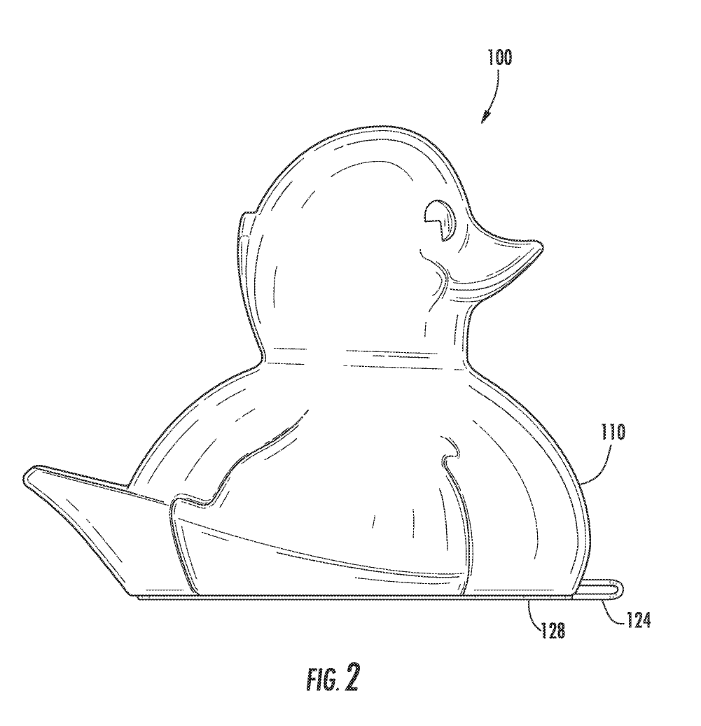

FIG. 2 shows a side view of the water toy 100 with flap 128 in the closed position. When flap 128 is in this closed position, enough air is entrapped in the inner chamber within main body 110 to enable water toy 100 to float.

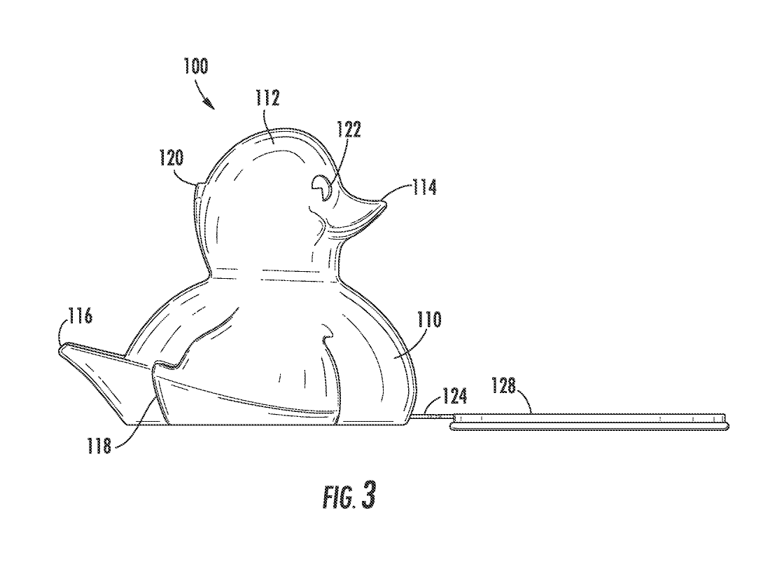

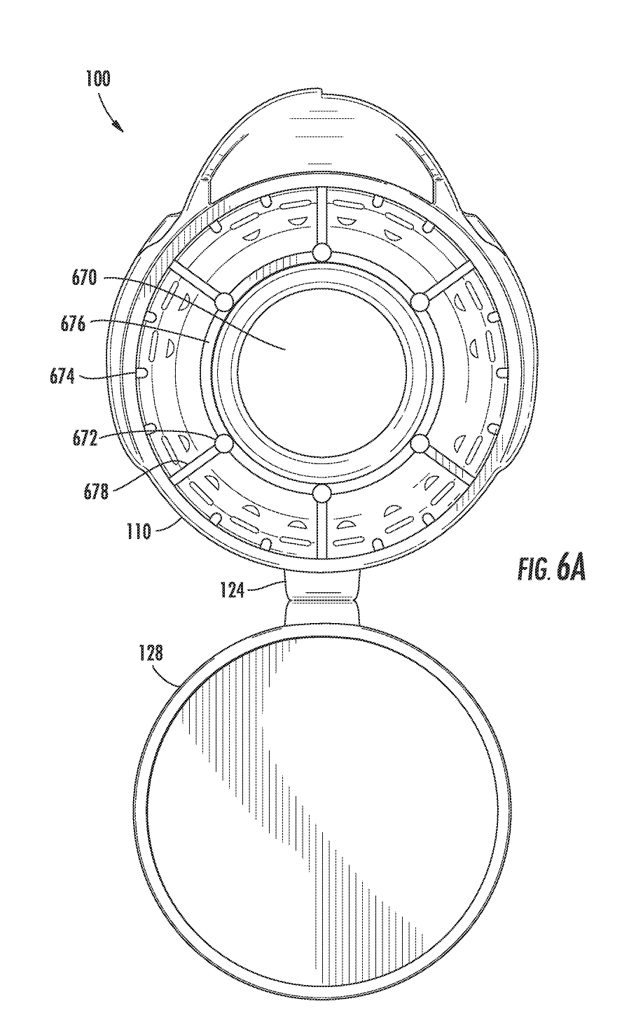

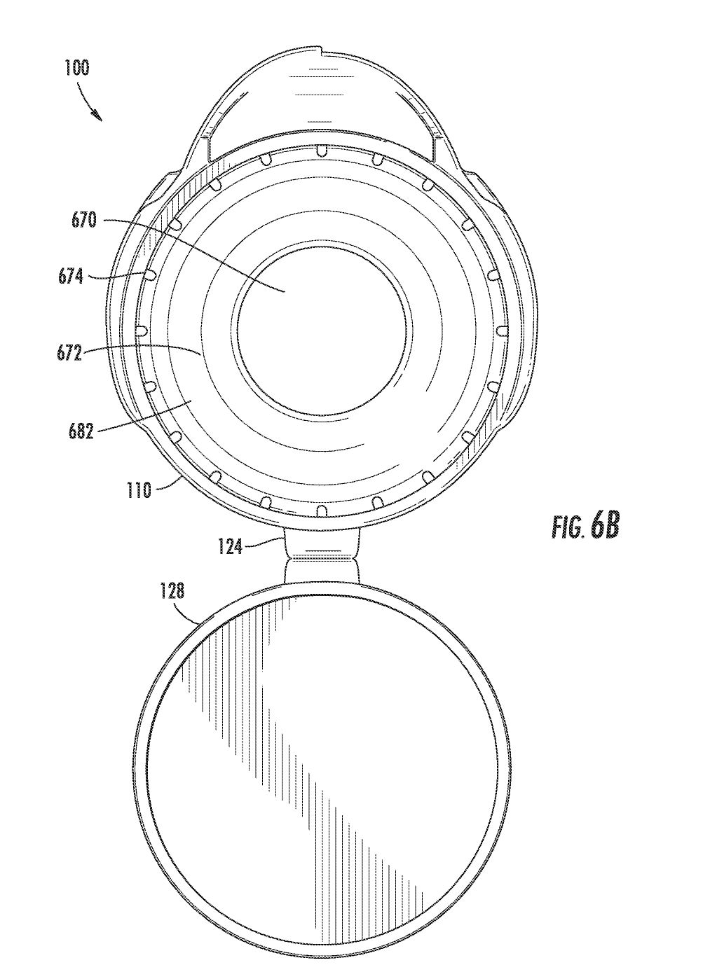

FIG. 3 depicts the side view of water toy 100 with flap 128 in the open position. Flap 128 can be opened by placing the thumb on one wing 118 and index finger on other wing 118 and gently squeezing inward, or by inserting a fingernail or other object between flap 128 and inner surface of the main body 110. When flap 128 is in the open position, inner chamber 670 is revealed (refer to FIG. 6A).

It is common for mold to form when stagnant water is encased in an area without drainage. It is known in the art that water toys may become a repository for mold because water may become trapped inside the toy with no opportunity to drain or dry this confined water. It is also known in the art that regular exposure to mold can result in an array of health concerns such as headaches, respiratory infections, congestion, skin irritation and death. The present invention water toy 100, has flap 128 that may be opened and closed. This is a significant aspect of the design because when flap 128 is in the open position, access is allowed to the interior of water toy 100 for draining, cleaning and drying any trapped water droplets or other materials located in the inner chamber, thus eliminating the risk of mold developing and accumulating inside the toy. In one embodiment, water toy 100 is dishwasher safe.

Beak 114, tail 116, wings 118 and eyes 122 will now be discussed. In one embodiment, all of these features are integral with main body 110 thus eliminating the need for additional operational steps, such as paint and assembling. These additional operational steps could add potentially hazardous materials to the invention. Streamlining the manufacturing process by taking out additional operational steps also saves production costs. In one embodiment of the invention, beak 114 extends forward from main body 110 and tail 116 extends rearward of main body 110. Both of these extremities may provide a teething surface. In other embodiments of the invention, these extremities could be depicted as other features of the toy, such as legs, a triangle or a wheel. Wings 118 are raised decorative panels with varying wall thickness. In other embodiments, there may not be wings or wings 118 could be in any other shape. Eyes 122 in this embodiment are circular-shaped with a cutout. In other embodiments, eyes 122 could be shaped differently, for example, triangular, rectangular or octagonal.

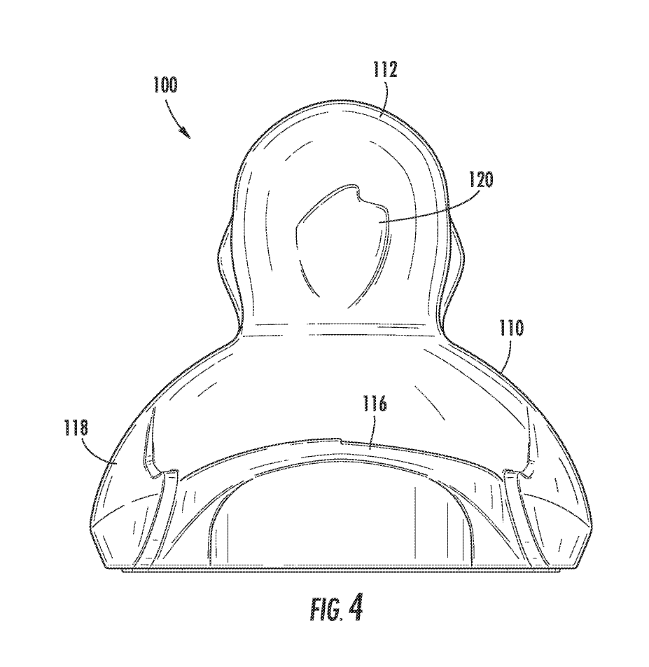

FIG. 4 details the rear view of water toy 100 with flap 128 in the closed position. In this view, hair tuft 120 is shown as being integral to main body 110. In this embodiment, hair tuft 120 is a raised enhancing feature. In other embodiments, there may not be hair tuft 120 or hair tuft 120 could be in any other shape. Again, because in this embodiment, this feature is integral with main body 110, the need for additional operational steps, such as paint and assembling, are eliminated.

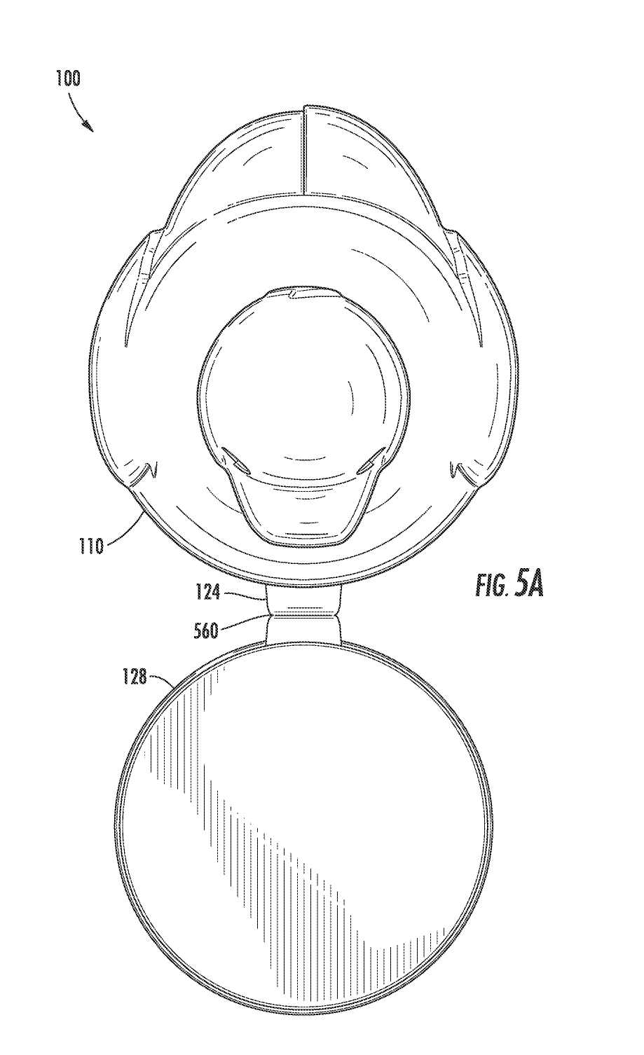

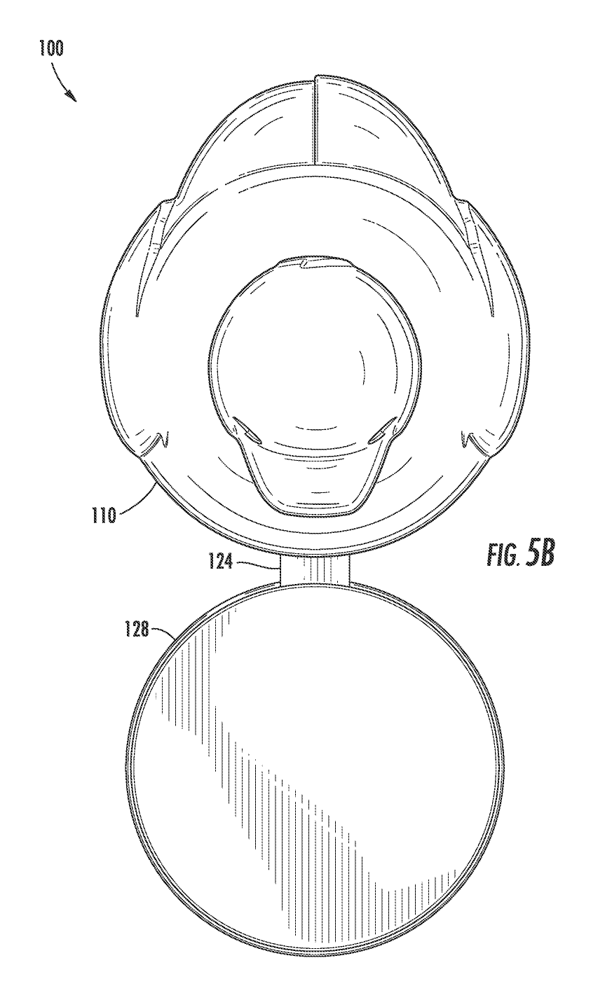

FIG. 5A is a top view of water toy 100 with flap 128 in the open position. In this embodiment, a narrow groove 560 extends perpendicular along the width of living hinge 124. Groove 560 assists with the operation of living hinge 124 so material on living hinge 124 does not impede the function of opening and closing hinge 124. In a second embodiment, FIG. 5B illustrates no groove on living hinge 124. In further embodiments, the groove may be narrower or wider or in a different shape.

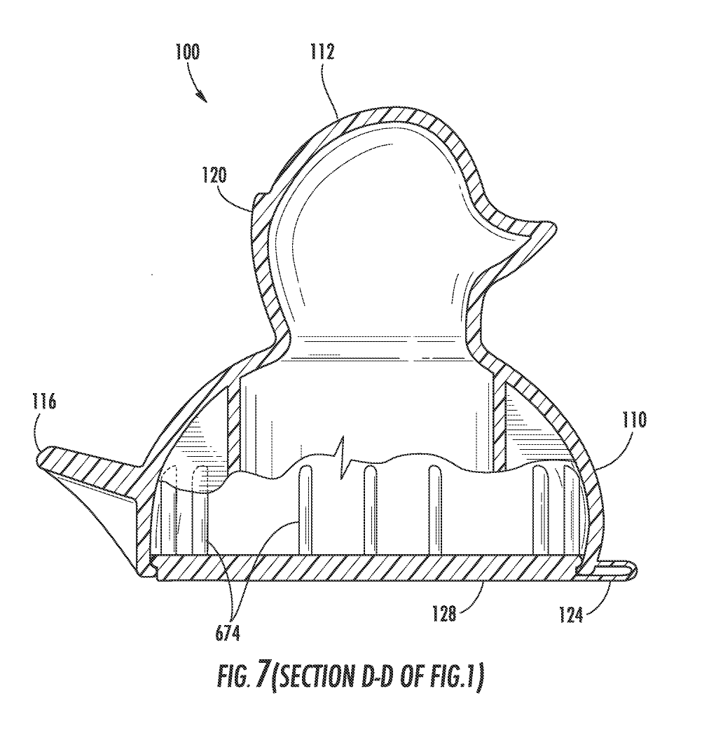

FIG. 6A provides a bottom view of water toy 100 with flap 128 in the open position, revealing a hollow cavity, also referred to as inner chamber 670, located inside main body 110. Contained within inner chamber 670, an inner structure 672 integral to main body 110 may exist. The purpose of inner structure 672 may be threefold. First, inner structure 672 may reinforce main body 110 providing rigidity and additional structure, thus water toy 110 cannot collapse upon itself. Second, because of the dimensions of inner structure 672, the risk of the user swallowing the toy, choking on the toy or suffocation while using the toy is minimized. The present invention conforms to all Consumer Product Safety Commission (CPSC) small parts regulations, specifically ASTM F973, and Consumer Product Safety Improvement Act of 2008 (CPSIA). Lastly, inner structure 672 may assist with maintaining flap 128 in the closed position, preventing flap 128 from opening during various tests. In this embodiment, flap 128 is closed by inserting it into inner chamber 670 where it is seated by ribs 674, shown in FIG. 7. Flap 128 then fits tightly to inner chamber 670 and to the inner surface of main body 110. In other embodiments, flap 128 could be held closed by various means, for example, snap fit designs, latching mechanisms or external fasteners.

In this embodiment, inner structure 672 is integral to main body 110 and consists of brace 676, spokes 678 and optionally, ribs 674. Brace 676 may be circular with a diameter not less than 1.25 inches and may be 1.5 inches located in the center of the lower portion of inner chamber 670, approximately 5/32 inches upward from the bottom surface of inner chamber 670. The material of brace 676 extends upward toward head 112 and connects to main body 110. Brace 676 may be further connected to main body 110 by spokes 678. In this embodiment, there may be six spokes 678 extending radially outward from brace 676 to the inner surface of main body 110. Ribs 674 may be approximately ⅝ inches in length, extending perpendicular to main body 110 and evenly spaced around the perimeter of inner chamber 670, as shown in FIG. 7.

FIG. 6B is a second embodiment for the configuration of inner structure 672. In this embodiment, inner structure 672 may again be integral to main body 110 and may consist of plate 682 and optionally, ribs 674. In this embodiment, plate 682 is a flat member with a circular cutout. The diameter of the cutout is not less than 1.25 inches and may be 1.5 inches. Plate 682 is attached to the inner surface of main body 110 and located in the lower portion of inner chamber 670, approximately 5/32 inches upward from the bottom surface of inner chamber 670. If ribs 674 are utilized, they may be approximately ⅝ inches in length, extending perpendicular to main body 110 and evenly spaced around the perimeter of inner chamber 670. In additional embodiments, inner structure 672 could consist of continuous reinforcements located across inner chamber 670 or any variation thereof that adds stability to main body 110, provides safety from choking and/or assists with maintaining flap 128 in the closed position.

FIG. 7 is section D-D of FIG. 1 and depicts a cutaway view of water toy 100 with flap 128 in the closed position further detailing inner chamber 670. Here, flap 128 is shown in relation to optional ribs 674 and optional ribs 674 are fully detailed. Also, varying wall thickness of main body 110 is illustrated. In other embodiments, the wall thickness may vary differently or not at all.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

The invention claimed is:

1. A water toy comprising:
an injection molded main body including an inside and an outside; and
an injection molded flap integral with the main body via a living hinge, the flap including an inner surface and an outer surface, the flap being in either an open or closed position, and the inner surface of the flap and the inside of the main body defining an inner chamber;
wherein the inner chamber is capable of containing enough air to enable the toy to float when the flap is in the closed position;
wherein the main body and the flap comprise a non-rigid material; and
wherein access is provided to the inner chamber for cleaning or drying when the flap is in the open position.

2. The water toy of claim 1, wherein the non-rigid material is an elastomer.

3. The water toy of claim 2, wherein the elastomer is a thermoplastic elastomer, thermoplastic polyurethane, low density polyethylene, a linear low density polyethylene, silicone, or other thermoset materials.

4. The water toy of claim 1, further comprising an inner structure located inside the chamber, the inner structure being integral with the main body.

5. The water toy of claim 1, wherein the inner structure reinforces the main body.

6. The water toy of claim 1, wherein the inner structure provides safety from choking and suffocation.

7. The water toy of claim 1, wherein the inner structure assists with maintaining the flap in the closed position.

8. The water toy of claim 1, wherein the toy is in the shape of a duck, a frog, a dolphin, a bear, a star or an automobile.

9. The water toy of claim 1, wherein the main body includes one or more teething protrusions.

10. The water toy of claim 9, wherein the teething protrusions are integral with the main body.

11. The water toy of claim 9, wherein the protrusions are in the shape of a beak and tail.

12. A water toy comprising:
an injection molded main body including an inside and an outside; and
an injection molded flap integral with the main body via a living hinge, the flap including an inner surface and an outer surface, the flap being in either an open or closed position, and the inner surface of the flap and the inside of the main body defining an inner chamber;
wherein the inner chamber is capable of containing enough air to enable the toy to float when the flap is in the closed position;
wherein the main body and the flap comprise a thermoplastic elastomer material; and
wherein access is provided to the inner chamber for cleaning or drying when the flap is in the open position.

13. The water toy of claim 12, further comprising an inner structure located inside the chamber, the inner structure being integral with the main body.

14. The water toy of claim 13, wherein the inner structure reinforces the main body.

15. The water toy of claim 13, wherein the inner structure provides safety from choking and suffocation.

16. The water toy of claim 13, wherein the inner structure assists with maintaining the flap in the closed position.

17. The water toy of claim 12, wherein the main body includes one or more teething protrusions.

18. The water toy of claim 17, wherein the teething protrusions are integral with the main body.

19. The water toy of claim 12, wherein the toy is in the shape of a duck, a frog, a dolphin, a bear, a star or an automobile.
